(19) United States
(12) Patent Application Publication
(10) Pub. No.: US 2021/0009724 A1
(43) Pub. Date: Jan. 14, 2021

(54) TRANSPARENT SHEET FOR FREEING FORMED FLOOR AND WALLBOARD FROM COATING WITH UV PAINT AND COATING

(71) Applicant: Weifang Jichang Plastic Co.,Ltd., Weifang City (CN)

(72) Inventor: Ruijie Wang, Zibo City (CN)

(21) Appl. No.: 16/538,832

(22) Filed: Aug. 13, 2019

(30) Foreign Application Priority Data
Jul. 9, 2019 (CN) 201910615465.0

(51) Int. Cl. C08F 14/06; C08K 5/12; C08K 5/09; C08K 5/57; C08K 3/014; C08J 5/18; E04F 13/18; E04F 15/10

(52) U.S. Cl. CPC C08F 14/06; C08K 5/12; C08K 5/09; C08K 5/57; C08J 2327/06; C08J 5/18; E04F 13/18; E04F 15/105; C08K 2201/014; C08K 3/014

(57) ABSTRACT

A transparent sheet for freeing formed floor and wallboard from coating with UV paint and coating, including following raw materials in parts by weight: 100 parts of PVC resin powder, 25-40 parts of plasticizer, 2-5 parts of stabilizer and 1-2 parts of lubricant. A method for preparing the transparent sheet: (1) weighing the raw materials according to a ratio of the PVC resin powder, the plasticizer, the stabilizer and the lubricant; and filtering the raw materials; (2) mixing the filtered raw materials and calendering the mixture by a calender to obtain a transparent sheet blank; (3) ultraviolet-curing the transparent sheet blank and coating a wear-resistant agent onto the transparent sheet blank to obtain the transparent sheet.

### TECHNICAL FIELD

The present disclosure relates to PVC production, in particular to a transparent sheet for freeing formed floor and wallboard from coating with UV (ultraviolet) paint and coating.

### BACKGROUND

PVC material, namely polyvinyl chloride, is one of the plastic products with the largest output in the world. It is cheap and widely used. PVC resin is white or light yellow powder and is not able to be used alone before being modified. PVC is white powder having an amorphous structure, a small branching degree and a poor stability to light and heat. The PVC resin can be added with different additives according to different purposes. Polyvinyl chloride plastic may present different physical and mechanical properties, and may be made into a variety of hard, soft and transparent products by adding an appropriate amount of the polyvinyl chloride resin.

The transparent sheet is a material used for covering the surface of a wallboard or floor to enhance the performance of the wallboard or the floor. However, the existing transparent sheet is not subjected to an ultraviolet-curing process. Thus, ultraviolet-curing treatment of wallboard or floor is required when the transparent sheet is covered on the wallboard or the floor, resulting in more production steps of wallboard or floor and higher production cost. Moreover, the existing transparent sheet has a poor performance of resistant to temperature, pressure and scratch, such that it is difficult to meet the needs of the people.

### SUMMARY OF THE APPLICATION

The main object of the present disclosure is to provide a transparent sheet for freeing formed floor and wallboard from coating with UV paint and coating, which can effectively solve the problems described in the background.

In order to achieve the above object, the technical solution adopted by the present disclosure is as follows.

A transparent sheet for freeing formed floor and wallboard from coating with UV paint and coating, including following raw materials in parts by weight: 100 parts of PVC resin powder, 25-40 parts of plasticizer, 2-5 parts of stabilizer and 1-2 parts of lubricant.

In some embodiments, the plasticizer is dioctyl phthalate; the stabilizer is selected from one of organotin stabilizer, transparent calcium-zinc composite stabilizer, transparent rare earth stabilizer; and the lubricant is stearic acid.

The present disclosure also provides a method for preparing the transparent sheet, the specific steps are as follows:
(1) weighing the raw materials according to a ratio of the PVC resin powder, the plasticizer, the stabilizer and the lubricant; and filtering the raw materials;
(2) mixing the filtered raw materials and calendering the mixture by a calender to obtain a transparent sheet blank;
(3) ultraviolet-curing the transparent sheet blank and coating a wear-resistant agent onto the transparent sheet blank to obtain the transparent sheet.

In some embodiments, the wear-resistant agent in step (3) is an emery grain wear-resistant agent.

In some embodiments, the raw material further includes a filler. The filler is an emery grain wear-resistant agent and the amount of the filler is 10-13 parts by weight.

The present disclosure also provides a method for preparing the transparent sheet, the specific steps are as follows:
(1) weighing the raw materials according to a ratio of the PVC resin powder, the plasticizer, the stabilizer, the lubricant and the filler, and filtering the raw materials;
(2) mixing the raw materials and calendering the mixture by a calender to obtain a transparent sheet blank;
(3) ultraviolet-curing the transparent sheet blank to obtain the transparent sheet.

In some embodiments, in step (a), the PVC resin powder is passed through a 40 mesh sieve to remove impurities, and the plasticizer is passed through a 100 mesh sieve to remove impurities.

Compared to prior arts, the present disclosure has the following beneficial effects.

The transparent sheet in the present disclosure is directly performed an ultraviolet-curing treatment in the producing process of the transparent sheet, such that it is not required to perform the ultraviolet-curing on the wallboard or the floor when the transparent sheet is applied to the wallboard or the floor. The transparent sheet prepared in the present disclosure can be directly covered on the surface of the wallboard or the floor, thereby reducing the production process of the wallboard or the floor and reducing the production cost.

The present disclosure greatly improves the abrasion resistance and scratch resistance of the transparent sheet by adding the emery grain wear-resistant agent to the transparent sheet raw material or coating the transparent sheet with the emery grain wear-resistant agent during the producing process of the transparent sheet.

The transparent sheet prepared in the present disclosure has a strong abrasion resistance and scratch resistance, and can reduce the processing process of the wallboard or the floor and reduce the production cost when it is applied to the wallboard or the floor.

### DETAILED DESCRIPTION OF THE EMBODIMENTS

In order to more clearly illustrate the technical means, the features, the object and the effects of the present invention, the present invention will be further described below with reference to the specific examples.

### Example 1

A transparent sheet for freeing formed floor and wallboard from coating with UV paint and coating, including following raw materials in parts by weight: 100 parts of PVC resin powder, 25-40 parts of plasticizer, 2-5 parts of stabilizer and 1-2 parts of lubricant.

The plasticizer is dioctyl phthalate; the stabilizer is selected from one of organotin stabilizer, transparent calcium-zinc composite stabilizer, transparent rare earth stabilizer; and the lubricant is stearic acid.

The present disclosure also provides a method for preparing the transparent sheet, the specific steps are as follows:
(1) weighing the raw materials according to a ratio of the PVC resin powder, the plasticizer, the stabilizer and the lubricant; and filtering the raw materials;
(2) mixing the filtered raw materials and calendering the mixture by a calender to obtain a transparent sheet blank;
(3) ultraviolet-curing the transparent sheet blank and coating a wear-resistant agent onto the transparent sheet blank to obtain the transparent sheet.

### Example 2

A transparent sheet for freeing formed floor and wallboard from coating with UV paint and coating, including following raw materials in parts by weight: 100 parts of PVC resin powder, 25-40 parts of plasticizer, 2-5 parts of stabilizer and 1-2 parts of lubricant.

The plasticizer is dioctyl phthalate; the stabilizer is selected from one of organotin stabilizer, transparent calcium-zinc composite stabilizer, transparent rare earth stabilizer; and the lubricant is stearic acid.

The raw material further includes a filler; the filler is an emery grain wear-resistant agent and the amount of the filler is 10-13 parts by weight.

The present disclosure also provides a method for preparing the transparent sheet, the specific steps are as follows:
(1) weighing the raw materials according to a ratio of the PVC resin powder, the plasticizer, the stabilizer, the lubricant and the filler, and filtering the raw materials;
(2) mixing the raw materials and calendering the mixture by a calender to obtain a transparent sheet blank;
(3) ultraviolet-curing the transparent sheet blank to obtain the transparent sheet.

In step (a), the PVC resin powder is passed through a 40 mesh sieve to remove impurities, and the plasticizer is passed through a 100 mesh sieve to remove impurities.

It can be seen from the first and second examples that the present disclosure greatly improves the abrasion resistance and scratch resistance of the transparent sheet by adding the emery grain wear-resistant agent to the transparent sheet raw material or coating the transparent sheet with the emery grain wear-resistant agent during the producing process of the transparent sheet.

In the production of existing wallboards or floors, it is necessary to perform surface treatment to the wallboards or the floors, that is, to apply a transparent sheet protective film to the wallboard and floors before ultraviolet-curing and coating. While, the transparent sheet in the present disclosure is directly performed an ultraviolet-curing treatment in the producing process of the transparent sheet, such that it is not required to perform the ultraviolet-curing on the wallboard or the floor when the transparent sheet is applied to the wallboard or the floor. The transparent sheet prepared in the present disclosure can be directly covered on the surface of the wallboard or the floor, thereby reducing the production process of the wallboard or the floor and reducing the production cost.

The basic principle, main features and advantages of the present invention are shown and described above. It should be understood by those skilled in the art that the present invention is not limited by the foregoing examples. The foregoing examples and descriptions only describe the principle of the present invention. Various changes and modifications are intended to be included within the scope of the invention as claimed without departing from the spirit and scope of the invention. The scope of the invention is defined by the appended claims and their equivalents.

What is claimed is:

1. A transparent sheet for freeing formed floor and wallboard from coating with UV paint and coating, comprising following raw materials in parts by weight: 100 parts of PVC resin powder, 25-40 parts of plasticizer, 2-5 parts of stabilizer and 1-2 parts of lubricant.

2. The transparent sheet of claim 1, wherein the plasticizer is dioctyl phthalate; the stabilizer is selected from one of organotin stabilizer, transparent calcium-zinc composite stabilizer and transparent rare earth stabilizer; the lubricant is stearic acid.

3. The transparent sheet of claim 1, wherein the raw materials further comprise a filler; the filler is an emery grain wear-resistant agent and the amount of the filler is 10-13 parts by weight.

4. A method for preparing the transparent sheet of claim 1, the specific steps are as follows:
(1) weighing the raw materials according to a ratio of the PVC resin powder, the plasticizer, the stabilizer and the lubricant; and filtering the raw materials;
(2) mixing the filtered raw materials and calendering the mixture by a calender to obtain a transparent sheet blank;
(3) ultraviolet-curing the transparent sheet blank and coating a wear-resistant agent onto the transparent sheet blank to obtain the transparent sheet.

5. The method of claim 4, wherein the wear-resistant agent in step (3) is an emery grain wear-resistant agent.

6. A method for preparing the transparent sheet of claim 3, the specific steps are as follows:
(a) weighing the raw materials according to a ratio of the PVC resin powder, the plasticizer, the stabilizer, the lubricant and the filler, and filtering the raw materials;
(b) mixing the raw materials and calendering the mixture by a calender to obtain a transparent sheet blank;
(c) ultraviolet-curing the transparent sheet blank to obtain the transparent sheet.

7. The method of claim 6, wherein in step (a), the PVC resin powder is passed through a 40 mesh sieve to remove impurities, and the plasticizer is passed through a 100 mesh sieve to remove impurities.
